(19) United States
(12) Patent Application Publication
(10) Pub. No.: US 2025/0233468 A1
(43) Pub. Date: Jul. 17, 2025

(54) ROTATING ELECTRIC MACHINE

(71) Applicant: HONDA MOTOR CO., LTD., Tokyo (JP)

(72) Inventor: Manabu Yazaki, Wako-shi (JP)

(21) Appl. No.: 19/014,904

(22) Filed: Jan. 9, 2025

(30) Foreign Application Priority Data
Jan. 17, 2024 (JP) 2024-005225

(51) Int. Cl. H02K 1/276; H02K 3/28

(52) U.S. Cl. CPC H02K 1/276; H02K 3/28

(57) ABSTRACT

A stator of a rotating electric machine includes a stator core. The stator core includes a plurality of teeth portions extending in the diametrical direction of a circular yoke portion having an annular shape. A slot is formed between adjacent teeth portions in a circumferential direction. In the slot, a dimension in a widthwise direction at a position of an inner circumferential side end surface of the electromagnetic coil is defined as a first distance. A separation distance between inner circumferential side end surfaces of the teeth portions adjacent to each other in the widthwise direction is defined as a second distance. The second distance is 0.5 times or more the first distance.

### CROSS-REFERENCE TO RELATED APPLICATIONS

This application is based upon and claims the benefit of priority from Japanese Patent Application No. 2024-005225 filed on Jan. 17, 2024, the contents of which are incorporated herein by reference.

### BACKGROUND OF THE INVENTION

### Field of the Invention

The present invention relates to a rotating electric machine equipped with a stator and a rotor.

### Description of the Related Art

A rotating electric machine is equipped with a stator and a rotor that rotates relatively with respect to the stator. The stator includes an electromagnetic coil provided in the slots of a stator core. On the other hand, the rotor has a plurality of permanent magnets. In the case that the rotating electric machine is a generator, the rotor is rotated. Due to such rotation, an induced current is generated in the electromagnetic coil.

As described in JP 2006-262603 A, it is known to arrange the plurality of permanent magnets in the rotor in a Halbach array. In this case, since the magnetic flux density or the amount of magnetic flux by the plurality of permanent magnets becomes large, it is anticipated that the efficiency is improved even in a case of a rotating electric machine that is small in scale.

In the case that the stator is incapable of sufficiently receiving such an amount of magnetic flux, a so-called leakage flux (leakage of magnetic flux) occurs. The leakage flux is one of the causes of the generation of the circulating current in the electromagnetic coil. The heat generated in the electromagnetic coil due to the circulating current results in losses. For such a reason above, in the case that a small rotating electric machine is used as a generator, it is not easy to increase the amount of generated electrical power.

The present applicant has proposed a structure in which a stator can sufficiently receive the amount of magnetic flux from a plurality of permanent magnets arranged in a Halbach array in JP 2022-055717 A. In this case, the leakage flux can be reduced.

### SUMMARY OF THE INVENTION

In a rotating electric machine, it is required to further reduce the leakage magnetic flux.

The present invention has the object of solving the aforementioned problem.

An aspect of the present disclosure is a rotating electric machine including a stator and a rotor disposed inside the stator. The stator includes a stator core and an electromagnetic coil. The stator core includes a yoke portion having an annular shape, a plurality of teeth portions provided at intervals in a circumferential direction of the stator, and each including a base portion protruding from an inner circumferential surface of the yoke portion and extending in a diametrical direction of the yoke portion as an extending direction, and the plurality of slots each being formed between adjacent ones of the plurality of teeth portions in the circumferential direction. The electromagnetic coil is provided in the slots.

The rotor includes a plurality of permanent magnets facing the plurality of teeth portions inside the stator. The plurality of permanent magnets include two or more combinations of a first magnet, a second magnet adjacent to the first magnet, a third magnet adjacent to the first magnet, and a fourth magnet adjacent to the third magnet, a direction of a magnetic field of the first magnet facing diametrically inward of the yoke portion, a direction of a magnetic field of the second magnet being a clockwise or counterclockwise direction, a direction of a magnetic field of the third magnet being a counterclockwise or clockwise direction opposite to the direction of the second magnet, and a direction of a magnetic field of the fourth magnet facing diametrically outward of the yoke portion.

A position of an inner circumferential side end surface of the electromagnetic coil is shifted from an inner circumferential side end of the base portion toward the yoke portion. A direction that is perpendicular to the extending direction is defined as a widthwise direction. In each of the plurality of the slots, a dimension of each of the slots in the widthwise direction at a position of the inner circumferential side end surface of the electromagnetic coil is defined as a first distance, and a separation distance between inner circumferential side end surfaces of the teeth portions adjacent to each other in the widthwise direction is defined as a second distance. In the above structure, the second distance is 0.5 times or more the first distance.

In accordance with the present disclosure, a rotating electric machine in which the leakage of magnetic flux in the stator is further reduced can be obtained.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic horizontal cross-sectional view of principal components of a rotating electric machine according to an embodiment of the present disclosure;

FIG. 2 is an enlarged view of principal components shown in FIG. 1;

FIG. 3 is an enlarged view of principal components of teeth portions each having no flange portion;

FIG. 4 is an enlarged view of principal components of teeth portions each having a tapered portion at an end of a base portion;

FIG. 5 is a graph showing a relationship between a distance from the inner circumferential side end surface of each of the teeth portions and the magnetic flux density in the rotating electric machine in which a second distance is about 0.8 times as long as a first distance;

FIG. 6 is a graph showing a relationship between the distance from the inner circumferential side end surface of each of the teeth portions and the magnetic flux density in the rotating electric machine in which the second distance is about 0.4 times as long as the first distance; and

FIG. 7 is a graph showing a relationship between the distance from the inner circumferential side end surface of each of the teeth portions and the magnetic flux density in the rotating electric machine in which the second distance is about 0.6 times as long as the first distance and the electromagnetic coil is formed by concentrated winding.

### DETAILED DESCRIPTION OF THE INVENTION

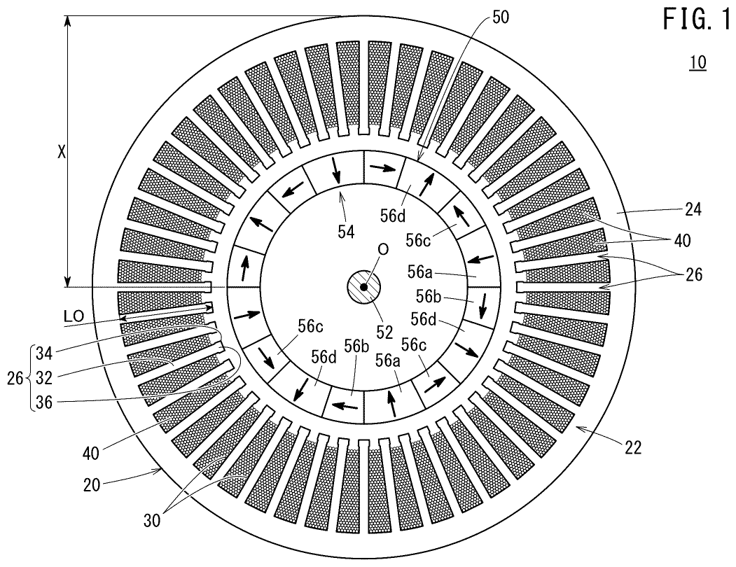

FIG. 1 is a schematic horizontal cross-sectional view of principal components of a rotating electric machine 10 according to the present embodiment. The rotating electric machine 10 includes a stator 20 having a substantially annular shape, and a rotor 50 disposed on an inner circumferential side of the stator 20. The rotating electric machine 10 constitutes a three-phase rotating electric machine (electric generator) having a U-phase, a V-phase, and a W-phase.

The stator 20 will be described. The stator 20 includes a stator core 22 and an electromagnetic coil 40. The stator core 22 is constituted, for example, by stacking magnetic bodies such as electromagnetic steel plates or the like. The stator core 22 includes a yoke portion 24 and a plurality of teeth portions 26. When a distance from a center O, which is the center of rotation of the rotor 50, to an outer circumferential surface of the yoke portion 24 is defined as X, an outer diameter of the stator core 22 is twice the distance X. In a typical example, the outer diameter of the stator core 22 is about 100 mm to 200 mm. The outer diameter is smaller in comparison with that of a general rotating electric machine. Stated otherwise, the rotating electric machine 10 according to the present embodiment has a small outer diameter and is small in scale. The outer diameter of the stator core 22 more preferably lies within a range of about 115 mm to 130 mm.

The plurality of teeth portions 26 are provided at intervals in the circumferential direction of the stator core 22. Each of the teeth portions 26 includes a base portion 32 starting from the inner circumferential surface of the yoke portion 24 and extending in the diametrical direction of the yoke portion 24. Most of each of the several teeth portions 26 is the base portion 32. The direction in which the base portion 32 extends is the diametrical direction of the yoke portion 24. Thus, the plurality of teeth portions 26 extend at intervals in the diametrical direction of the stator core 22. The configuration of each of the teeth portions 26 will be described in detail later.

Slots 30 are formed between circumferentially adjacent ones of the plurality of teeth portions 26. From the fact that the rotating electric machine 10 is a three-phase electrical power generator, the number of the slots 30 is typically set to a multiple of three. More specifically, the number of the slots 30, for example, is 24, 30, 36, 48, and the like. In the example shown in FIG. 1, both the number of teeth portions 26 and the number of slots 30 are 48. The number of poles (to be described later) is 8. In this case, the rotating electric machine 10 is configured in the form of a so-called 8-pole 48-slot rotating electric machine.

The electromagnetic coil 40 is constituted, for example, by winding a wire material made of copper around the teeth portions 26. A portion of the wire material is passed through the slot 30. The electromagnetic coil 40 is provided in the slots 30. Distributed winding is a preferable form when the wire material is wound around the teeth portions 26 and the slots 30. The wire material may be wound around the teeth portions 26 by concentrated winding.

For example, instead of winding the wire material around the teeth portions 26, the electromagnetic coil 40 may be configured by inserting leg members each made of a metal conductor and having a substantially U-shape into the slots 30, as shown in FIG. 1 of JP 2020-039207 A.

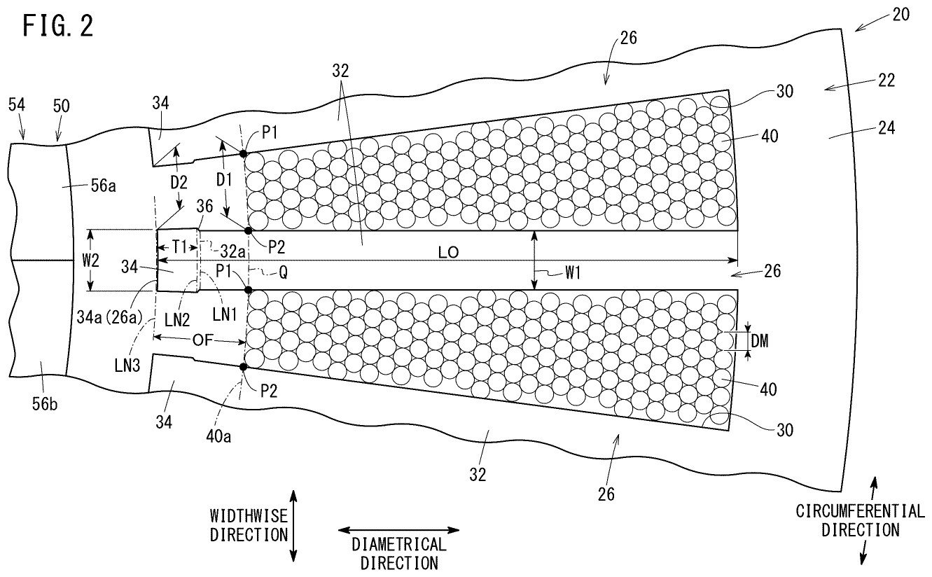

The configuration of the teeth portions 26 will be described. As shown in FIG. 2, each of the plurality of teeth portions 26 has the base portion 32. A direction that is perpendicular to the diametrical direction of the stator core 22 is defined as a widthwise direction. In the embodiment shown in FIG. 2, a first width dimension W1, which is a dimension in the widthwise direction, is substantially constant in the base portion 32. In the embodiment, each of the teeth portions 26 has a flange portion 34 located further on the inner circumferential side than the base portion 32 and an expanding portion 36 interposed between the base portion 32 and the flange portion 34.

The expanding portion 36 expands in a manner so as to gradually widen, expands from the base portion 32 toward the flange portion 34. The expansion starts at a first virtual straight line LN1 and ends at the second virtual straight line LN2. Accordingly, the first virtual straight line LN1 is an inner circumferential side end 32a of the base portion 32 and an outer circumferential side end of the expanding portion 36. The second virtual straight line LN2 is an inner circumferential side end of the expanding portion 36 and an outer circumferential side end of the flange portion 34. The third virtual straight line LN3 is an inner circumferential side end surface 34a of the flange portion 34.

The flange portion 34 has a second width dimension W2 in the widthwise direction. The second width dimension W2 of the flange portion 34 is larger than the first width dimension W1 of the base portion 32.

The flange portion 34 has a thickness T1. The thickness T1 of the flange portion 34 is the shortest distance from the inner circumferential side end surface 34a of the flange portion 34 to the outer circumferential side end of the flange portion 34. More specifically, the thickness T1 of the flange portion 34 is the separation distance between the second virtual straight line LN2 and the third virtual straight line LN3. The thickness T1 of the flange portion 34 is preferably 0.2 mm to 2.0 mm. The thickness T1 of the flange portion 34 is more preferably in the range of 0.3 mm to 1.1 mm.

A total length LO of each of the teeth portions 26 is defined as a linear distance from the inner circumferential surface of the yoke portion 24, which is the starting point of the base portion 32, to the inner circumferential side end surface 34a of the flange portion 34. In the case that the diameter of the stator core 22 is within the above range of numerical values, the total length LO of each of the teeth portions 26 is within the range of, for example, 40 mm to 45 mm. When the total length LO of each of the teeth portions 26 is 100%, the total length of each of the base portion 32 is preferably 96% or more. That is, in this case, the distance from the inner circumferential side end surface 34a of the flange portion 34 to the inner circumferential side end 32a of the base portion 32 is preferably set to less than or equal to 4% of the total length LO of each of the teeth portions 26.

In the slot 30, the position of an inner circumferential side end surface 40a of the electromagnetic coil 40 is shifted toward the yoke portion 24. That is, the direction of the shifting of the electromagnetic coil 40 is diametrically outward. A linear distance from the inner circumferential side end surface 34a of the flange portion 34 to the inner circumferential side end surface 40a of the electromagnetic coil 40 is defined as a shift amount (offset amount) OF. The shift amount OF is preferably 5% to 11% of the total length LO of each of the teeth portions 26. For example, when the total length LO of each of the teeth portions is 40 mm, the preferable shift amount OF is 2 mm to 4.4 mm. The shift amount OF is more preferably 5.6% to 10.3% of the total length LO of each of the teeth portions 26.

If the shift amount OF is less than 5% of the total length LO of each of the teeth portions 26, the number of times at which the electromagnetic coil 40 is wound around the teeth portions 26 and the slots 30 becomes larger in quantity. In particularly, the volume of the electromagnetic coil 40 becomes large. Accordingly, the amount of magnetic flux received by the electromagnetic coil 40 from the plurality of permanent magnets 54 increases. As a result, the amount of heat generated by the electromagnetic coil 40 may increase. In addition, the copper loss in the electromagnetic coil 40 increases. On the other hand, if the shift amount OF is in excess of 11%, although the copper loss in the electromagnetic coil 40 is small, the exposed area of the base portion 32 may become large. In this case, the iron loss and the heat generation amount may be increased in the teeth portions 26. In addition, since the amount of winding of the electromagnetic coil 40 around the teeth portions 26 and the slots 30 is reduced, the output of the electrical power generator tends to be reduced.

Moreover, when the total length LO of each of the teeth portions 26 is 40 mm to 45 mm, the specific distance from the first virtual straight line LN1, that is defined as the inner circumferential side end 32a of the base portion 32 (the outer circumferential side end of the expanding portion 36), to the inner circumferential side end surface 40a of the electromagnetic coil 40 is, for example, on the order of 1 mm to 3 mm.

In the slot 30, a dimension in the widthwise direction at the position of the inner circumferential side end surface 40a of the electromagnetic coil 40 is defined as a first distance D1. The first distance D1 is specifically defined as follows. A virtual circle Q is drawn passing through the inner circumferential side end surface 40a of the electromagnetic coil 40. A point where the virtual circle Q intersects one of the teeth portions 26 adjacent to each other is defined as a first intersection point P1. A point where the virtual circle Q intersects the remaining one of the teeth portions 26 adjacent to each other is defined as a second intersection point P2. The first distance D1 is the length of a straight line connecting the first intersection point P1 and the second intersection point P2.

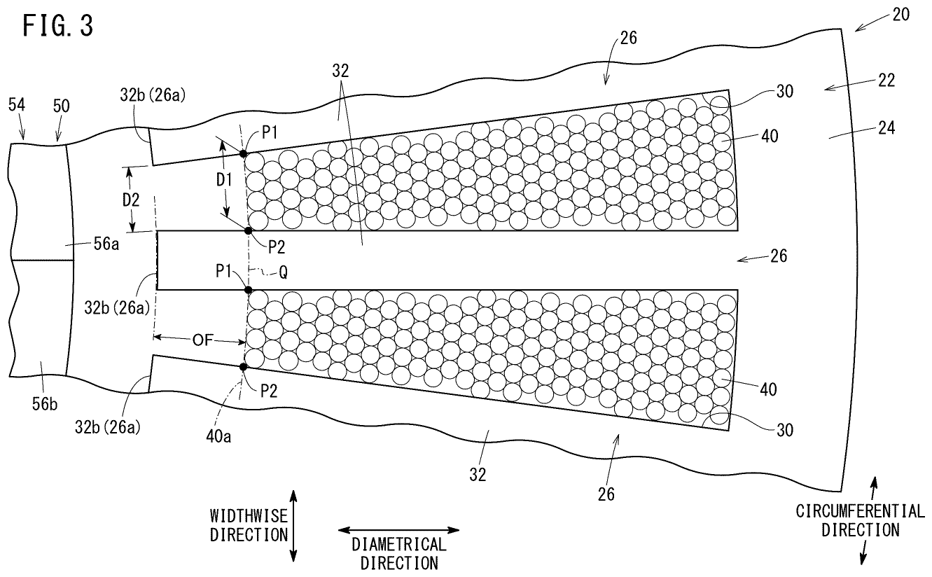

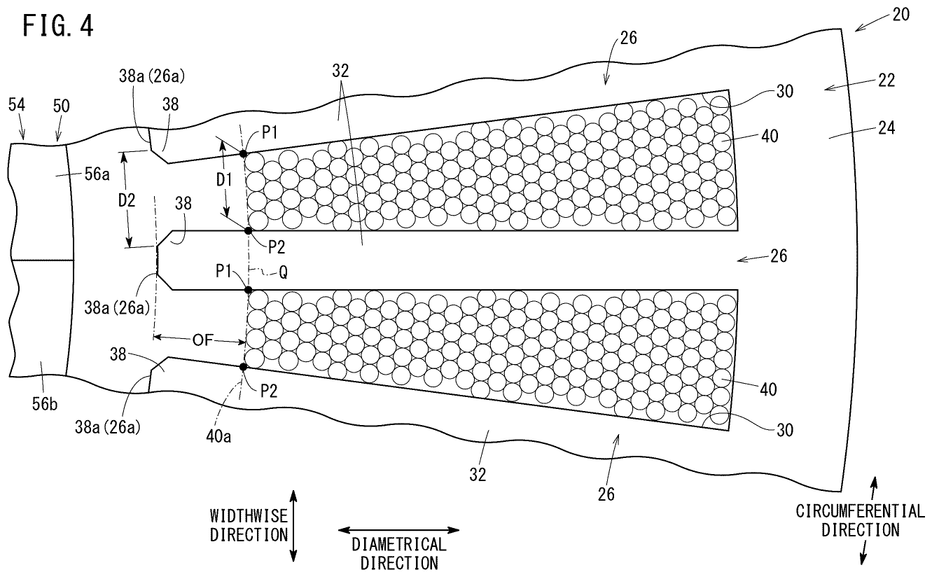

The separation distance between the inner circumferential side end surfaces 26a of the teeth portions 26 adjacent to each other in the widthwise direction is defined as a second distance D2. In the rotating electric machine 10 of the illustrated example, the inner circumferential side ends of the teeth portions 26 are the flange portions 34. In this embodiment, the inner circumferential side end surface 26a of each of the teeth portions 26 refers to the inner circumferential side end surface 34a of the flange portion 34. As shown in FIG. 3, which will be described later, in the embodiment in which each of the teeth portions 26 has only the base portion 32 without the expanding portion 36 and the flange portion 34, an inner circumferential side end surface 32b of the base portion 32 corresponds to the inner circumferential side end surface 26a of each of the teeth portions 26. As shown in FIG. 4, which will be described later, in the embodiment in which each of the teeth portions 26 has the base portion 32 and a tapered portion 38 formed on the inner circumferential side of the base portion 32, an inner circumferential side end surface 38a of the tapered portion 38 corresponds to the inner circumferential side end surface 26a of each of the teeth portions 26.

The first distance D1 and the second distance D2 defined as described above have a relationship shown in a following inequality (A).

$$0.5 \times D 1 \leq D 2 \qquad ( A )$$

That is, the second distance D2 is 0.5 times or more the first distance D1. By establishing this relationship between the first distance D1 and the second distance D2, the amount of magnetic flux at the ends of the teeth portions 26 (the flange portions 34 in this embodiment) can be reduced as compared with the case where the second distance D2 is 0.5 times or less of the first distance D1.

As shown in FIGS. 1 and 2, when the teeth portions 26 have the flange portions 34, the second distance D2 is smaller than the first distance D1. That is, a relationship shown in a following inequality (B) is established.

$$0.5 \times D 1 \leq D 2 < D 1 \qquad ( B )$$

In this case, the magnetic flux from the plurality of permanent magnets 54 can be sufficiently received by the flange portions 34 while the magnetic flux amount is prevented from becoming excessively large in the flange portions 34.

As shown in FIG. 3, the above-described inequality (B) can be satisfied even in the embodiment in which each of the teeth portions 26 has only the base portion 32. In this case, the magnetic flux from the plurality of permanent magnets 54 can be sufficiently received by the inner circumferential side end surface 32b of the base portion 32 while the magnetic flux amount is prevented from becoming excessively large in the inner circumferential side end surface 32b of the base portion 32.

For the above reasons, it is preferable for the above inequality (B) to be satisfied. However, it is not essential for the inequality (B) to hold. As shown in FIG. 4, in the embodiment in which each of the teeth portions 26 has the base portion 32 and the tapered portion 38, a following inequality (C) may be satisfied.

$$0.5 \times D 1 < D 1 < D 2 \qquad ( C )$$

In this configuration, the amount of magnetic flux received by the tapered portion 38 is smaller than that of the flange portion 34 (FIGS. 1 and 2). Therefore, the amount of magnetic flux is prevented from becoming excessively large at the tapered portion 38.

The second distance D2 is preferably larger than a diameter DM of the wire material of the electromagnetic coil 40. In this case, the saturation magnetic flux at the end of each of the teeth portions 26 is reduced, and therefore the magnetic flux that the teeth portions 26 can receive is increased. Accordingly, it is possible to achieve an enhancement in the rotational torque of the rotating electric machine 10. Further, as the material (electromagnetic steel plates or the like) of the stator core 22, it becomes possible to select magnetic bodies for which the saturation magnetic flux density thereof is small. Accordingly, material costs can be reduced.

The rotor 50 will be described. As shown in FIG. 1, the rotor 50 includes a rotating shaft 52 and the plurality of permanent magnets 54. The plurality of permanent magnets 54 are retained by the rotating shaft 52.

The plurality of permanent magnets 54 include combinations of first magnets 56a, second magnets 56b, third magnets 56c, and fourth magnets 56d. In each combination, one of the first magnets 56a, one of the second magnets 56b, one of the third magnets 56c, and one of the fourth magnets 56d are included. In FIG. 1, there are four combinations of the first magnets 56a, the second magnets 56b, the third magnets 56c, and the fourth magnets 56d. Accordingly, the number of the plurality of permanent magnets 54 is 16.

In FIG. 1, arrows shown in the first to fourth magnets 56a to 56d indicate the directions of the magnetic fields of the first to fourth magnets 56a to 56d, respectively. As can be understood from FIG. 1, the direction of the magnetic field of the first magnet 56a is a direction diametrically inward of the rotor 50 and the stator core 22. The direction of the magnetic field of the fourth magnet 56d is a direction diametrically outward of the rotor 50 and the stator core 22. That is, the directions of the magnetic field of the first magnets 56a and the directions of the magnetic field of the fourth magnets 56d are opposite to each other.

In FIG. 1, the direction of the magnetic field of the second magnet 56b is a clockwise direction in the circumferential direction of the rotor 50 and the stator core 22. The direction of the magnetic field of the third magnet 56c is a counterclockwise direction in the circumferential direction of the rotor 50 and the stator core 22. That is, the direction of the magnetic field of the second magnet 56b and the direction of the magnetic field of the third magnet 56c are opposite to each other.

In one combination, the first magnet 56a, the second magnet 56b, the fourth magnet 56d, and the third magnet 56c are arranged in this order in the clockwise direction in FIG. 1. That is, in this embodiment, the sixteen permanent magnets 54 are arranged in the Halbach array. The first magnets 56a to the fourth magnets 56d face toward the base portions 32 via the flange portions 34 of the teeth portions 26. In the present embodiment, the number of poles is defined as twice the number of combinations (number of sets) of the first to fourth magnets 56a to 56d. Accordingly, in the rotating electric machine 10 shown in FIG. 1, the number of poles is eight. The number of poles may be 10 or 12. In this way, the typical number of poles is an even number from 8 to 12 inclusive.

The rotating shaft 52 retaining the plurality of permanent magnets 54 is connected to an output shaft of an internal combustion engine such as a gas turbine engine. Accordingly, the output shaft rotates in accordance with the operation of the internal combustion engine, and the rotating shaft 52 rotates accordingly. The internal combustion engine and the output shaft are not illustrated.

However, the rotating electric machine 10 can be used alone. That is, it is not essential to connect the rotating electric machine 10 with an internal combustion engine (gas turbine engine or the like).

Next, the operation of the rotating electric machine 10 will be described by way of example in the case that the rotating shaft 52 is connected to the output shaft of the gas turbine engine.

In the case that the rotating electric machine 10 is used as an electrical power generator, the rotating shaft 52 is rotated by a starter (not shown). Accordingly, the output shaft of the gas turbine engine rotates, and the fuel and the compressed air are supplied into the gas turbine engine. Thereafter, the rotating shaft 52 rotates following the rotation of the output shaft.

As the rotating shaft 52 rotates, an alternating magnetic field is generated between the first magnet 56a to the fourth magnets 56d, and the electromagnetic coil 40. Further, an induced current flows through the electromagnetic coil 40. The induced current is taken out of the rotating electric machine 10 and used as electric energy for driving a predetermined external load (equipment), for example.

The rotating electric machine 10 may be operated as a motor. In this case, an alternating current is applied to the electromagnetic coil 40 from an external power source.

The present embodiment exhibits the following advantageous effects.

As shown in FIG. 2, in the slot 30, a dimension in the widthwise direction at the position of the inner circumferential side end of the electromagnetic coil 40 is defined as the first distance D1. Further, the separation distance between the inner circumferential side end surfaces 26a of the teeth portions 26 adjacent to each other in the widthwise direction is defined as the second distance D2. The first distance D1 and the second distance D2 defined in this manner satisfy the following inequality (A).

$$0.5 \times D 1 \leq D 2 \qquad ( A )$$

That is, the second distance D2 is 0.5 times or more the first distance D1.

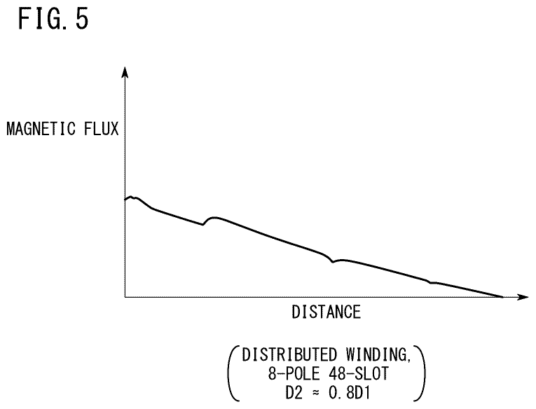

FIG. 5 is the graph showing the relationship between the distance from the inner circumferential side end surface 26a of each of the teeth portions 26 and the magnetic flux density in the rotating electric machine in which the second distance D2 is about 0.8 times as long as the first distance D1. That is, in this rotating electric machine 10, the following inequality (B′) is satisfied.

$$0.5 \times D 1 < D 2 ( \approx 0.8 \times D 1 ) < D 1 \qquad ( {B}^{′} )$$

As shown in FIGS. 1 and 2, each of the teeth portions 26 includes the base portion 32, the expanding portion 36, and the flange portion 34. The second distance D2 is a separation distance in the widthwise direction between the inner circumferential side end surfaces 34a of the flange portions 34 adjacent to each other.

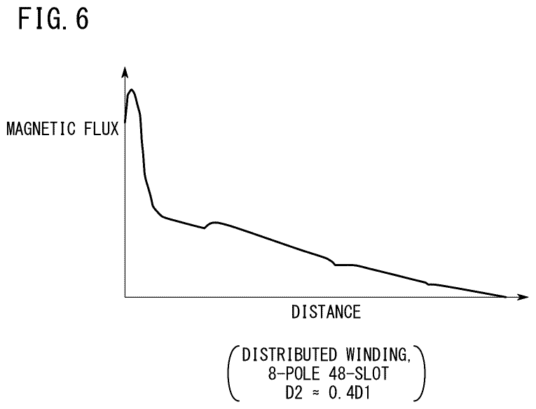

On the other hand, FIG. 6 is the graph showing the relationship between the distance from the inner circumferential side end surface 26a of each of the teeth portions 26 and the magnetic flux density in the rotating electric machine in which the second distance D2 is about 0.4 times as long as the first distance D1. That is, in this rotating electric machine 10, the first distance D1 and the second distance D2 have the following relationship.

$$D 2 ( \approx 0.4 \times D 1 ) < 0.5 \times D 1$$

In this case, the second width dimension W2 (see FIG. 2) of the flange portion 34 is larger than that in the case of FIG. 5, and the second distance D2 is about 0.5 times.

As can be understood by comparing FIGS. 5 and 6, in the rotating electric machine 10 in which the inequality (A) is satisfied, the magnetic flux density at the inner circumferential side end of each of the teeth portions 26 is reduced as compared with the rotating electric machine 10 in which the inequality (A) is not satisfied. As described above, the magnetic flux density at the inner circumferential side end of each of the teeth portions 26 is reduced if the first distance D1 and the second distance D2 have the relationship shown in the inequality (A). In accordance with this feature, the leakage flux in the stator 20 is reduced, and thus the circulating current in the electromagnetic coil 40 is reduced. Accordingly, the loss caused by the circulating current can be reduced.

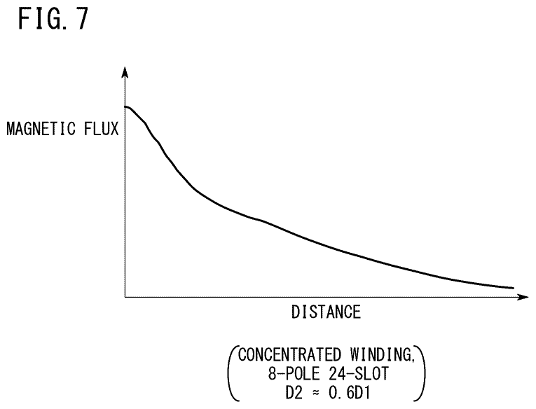

FIGS. 5 and 6 show the results obtained when the electromagnetic coil 40 is wound around the teeth portions 26 and the slots 30 by distributed winding. FIG. 7 shows the result obtained when the electromagnetic coil 40 is wound around the teeth portions 26 and the slots 30 by concentrated winding. This rotating electric machine 10 is configured in the form of an 8-pole 24-slot rotating electric machine, and the second distance D2 is about 0.6 times the first distance D1. From FIG. 7, it is understood that the magnetic flux density at the inner circumferential side end of each of the teeth portions 26 is reduced by satisfying the relationship of the above inequality (A), even in the case that the electromagnetic coil 40 is wound around the teeth portions 26 and the slots 30 by concentrated winding.

As shown in FIG. 1, the plurality of permanent magnets 54 form the Halbach array. Therefore, the magnetic field strength from the rotor 50 (the plurality of permanent magnets 54) toward the stator 20 is large. In the rotating electric machine 10 satisfying the above inequality (B), the teeth portions 26 can receive the magnetic flux sufficiently from the plurality of permanent magnets 54. Therefore, the torque of the rotating electric machine 10 increases.

As shown in FIGS. 1 and 2, each of the teeth portions 26 has the flange portion 34. Since the flange portion 34 is wider than the base portion 32, the teeth portions 26 can receive more magnetic flux from the plurality of permanent magnets 54.

In the embodiment in which each of the teeth portions 26 has the flange portion 34, the shift amount OF shown in FIG. 2 is 5% to 11% of the total length LO of each of the teeth portions 26. In the case that the shift amount is defined in this manner, it is possible to increase the output of electrical power generator while the leakage of magnetic flux is reduced. As a result, it is possible to prevent the teeth portions 26, the electromagnetic coil 40, and the like from causing a local rise in temperature. Therefore, deterioration of the material (electromagnetic steel plate or the like) of the stator core 22 or the material (copper or the like) of the electromagnetic coil 40 due to such a rise in temperature is suppressed.

When the total length LO of each of the teeth portions 26 is 100%, the length of the base portion 32 is 96% or more.

In this case, the amount of winding of the electromagnetic coil 40 around the teeth portions 26 and the slots 30 is appropriate. Therefore, the rotating electric machine 10 can constitute an electrical power generator having a sufficient output. In addition, in the rotating electric machine 10, the iron loss and the copper loss are small.

The thickness T1 of the flange portion 34 (the distance from the inner circumferential side end surface 34a to the outer circumferential side end) is 0.2 mm to 2.0 mm.

The flange portion 34 having such a thickness T1 can easily receive the magnetic flux from the plurality of permanent magnets 54. Accordingly, leakage of magnetic flux is further reduced. In addition, in the stator 20 having the flange portions 34, an increase in the iron loss is suppressed.

As exemplified in FIG. 1, when the number of poles is defined as twice the number of combinations of the first to fourth magnets 56a to 56d, the number of poles is an even number from 8 to 12 inclusive, and the number of teeth portions 26 is a multiple of three and is 24 or more and 48 or less.

In this configuration, the rotor 50 can rotate at high speed because the number of poles and the number of teeth portions 26 are large. Moreover, the rotating electric machine 10 can be configured as an electrical power generator having a large output.

The outer diameter of the stator core 22 (twice the distance X in FIG. 1) is 100 mm to 200 mm.

In this case, the rotating electric machine 10 is relatively small. However, even though the size of the rotating electric machine 10 is small, the rotating electric machine 10 exhibits a large output.

In the case that the outer diameter of the stator core 22 is within the above range, the total length LO of each of the teeth portions 26 is 40 mm to 45 mm.

In this case, the amount of winding of the electromagnetic coil 40 around the teeth portions 26 and the slots 30 is appropriate. Therefore, a sufficient output can be obtained in the rotating electric machine 10. Further, in accordance with such a configuration, the iron loss and the copper loss can be suppressed.

In the foregoing manner, according to the present embodiment, it is possible to cause an enhancement in torque while suppressing generation of heat in the rotating electric machine 10. Further, in the case that the rotating electric machine 10 is used as an electrical power generator, it is possible to improve the amount of generated electrical power.

The following supplementary notes are further disclosed in relation to the above-described embodiment.

### Supplementary Note 1

The rotating electric machine (10) includes the stator (20) and the rotor (50) disposed inside the stator. The stator includes the stator core (22) and the electromagnetic coil (40). The stator core includes the yoke portion (24) having an annular shape, the plurality of teeth portions (26) provided at intervals in the circumferential direction of the stator, and each including the base portion (32) protruding from the inner circumferential surface of the yoke portion and extending in the diametrical direction of the yoke portion as the extending direction, and the plurality of slots (30) each being formed between adjacent ones of the plurality of teeth portions in the circumferential direction. The electromagnetic coil is provided in the slots.

The rotor includes the plurality of permanent magnets (54) facing the plurality of teeth portions inside the stator. The plurality of permanent magnets include two or more combinations of the first magnet (56a), the second magnet (56b) adjacent to the first magnet, the third magnet (56c) adjacent to the first magnet, and the fourth magnet (56d) adjacent to the third magnet, the direction of the magnetic field of the first magnet facing diametrically inward of the yoke portion, the direction of the magnetic field of the second magnet being the clockwise or counterclockwise direction, the direction of the magnetic field of the third magnet being the counterclockwise or clockwise direction opposite to the direction of the second magnet, and the direction of the magnetic field of the fourth magnet facing diametrically outward of the yoke portion. The position of the inner circumferential side end surface (40a) of the electromagnetic coil is shifted from the inner circumferential side end (32a) of the base portion toward the yoke portion.

The direction that is perpendicular to the extending direction is defined as the widthwise direction. In each of the plurality of the slots, the dimension of each of the slots in the widthwise direction at the position of the inner circumferential side end surface of the electromagnetic coil is defined as the first distance (D1), and the separation distance between inner circumferential side end surfaces (26a) of the teeth portions adjacent to each other in the widthwise direction is defined as the second distance (D2). In the above configuration, the second distance is 0.5 times or more the first distance.

The second distance corresponds to an inner circumferential side opening facing the rotor in the slot. That is, in the above configuration, the opening on the inner circumferential side of the slot is relatively large. In this case, the magnetic flux density at the distal ends of the teeth portions is reduced as compared with a case where the inner circumferential side opening of the slot is small. Therefore, leakage flux in the stator is reduced, and thus a circulating current in the electromagnetic coil is reduced. Accordingly, the loss caused by the circulating current can be reduced.

### Supplementary Note 2

In the rotating electric machine according to the supplementary note 1, the second distance may be smaller than the first distance.

In this case, the teeth portions can receive the magnetic flux from the plurality of permanent magnets sufficiently.

### Supplementary Note 3

In the rotating electric machine according to the supplementary note 1 or 2, each of the teeth portions may include the flange portion (34) which is located further on the inner circumferential side of the stator core than an inner circumferential side end of the base portion, and which has the dimension (W2) in the widthwise direction larger than the dimension in the widthwise direction of the base portion, and the electromagnetic coil may be shifted from the inner circumferential side end surface (34a) of the flange portion by the shift amount (OF) of 5% to 11% of the total length (LO) of each of the teeth portions.

Since the flange portion is wider than the base portion, the teeth portions can receive more magnetic flux from the first to fourth magnets.

Moreover, in the case that the shift amount is within the above range, it is possible to increase the output of electrical power generator while the leakage of magnetic flux is reduced. As a result, it is possible to prevent the teeth portions, the electromagnetic coil, and the like from causing a local rise in temperature. Therefore, deterioration of the electromagnetic steel plate as the material of the stator core or the copper or the like as the material of the electromagnetic coil due to such a rise in temperature is suppressed.

### Supplementary Note 4

In the rotating electric machine according to the supplementary note 2 or 3, when the total length of each of the teeth portions is 100%, the length of the base portion may be 96% or more.

In this case, the amount of winding of the electromagnetic coil around the teeth portions and the slots is appropriate. Therefore, the rotating electric machine can constitute an electrical power generator having a sufficient output. Further, in accordance with such a configuration, the iron loss and the copper loss can be suppressed.

### Supplementary Note 5

In the rotating electric machine according to any one of the supplementary notes 2 to 4, the distance (thickness T1) from the inner circumferential side end surface to the outer circumferential side end portion of the flange portion may be 0.2 mm to 2.0 mm.

In accordance with such a configuration, the flange portion can easily receive the magnetic flux from the plurality of permanent magnets. Accordingly, leakage of magnetic flux is further reduced. In addition, an increase in the iron loss in the stator is suppressed.

### Supplementary Note 6

In the rotating electric machine according to any one of the supplementary notes 1 to 5, when the number of poles is defined as twice the number of combinations of the first magnet to the fourth magnet, the number of poles may be the even number of 8 or more and 12 or less, and the number of the teeth portions may be a multiple of three and be 24 or more and 48 or less.

In this configuration, the rotor can rotate at high speed because the number of poles and the number of teeth portions are large. Moreover, the rotating electric machine can be configured as an electrical power generator having a large output.

### Supplementary Note 7

In the rotating electric machine according to any one of the supplementary notes 1 to 6, the outer diameter of the stator core may be 100 mm to 200 mm.

A rotating electric machine having the stator core with the outer diameter within the above range exhibits a large output despite its relatively small size.

### Supplementary Note 8

In the rotating electric machine according to the supplementary note 7, the total length of each of the teeth portions may be 40 mm to 45 mm.

In this case, in the rotating electric machine in which the outer diameter of the stator core is within the above range, the winding amount of the electromagnetic coil around the teeth portions and the slots is appropriate. Therefore, the rotating electric machine exhibits a sufficient output. Further, in accordance with such a configuration, the iron loss and the copper loss can be suppressed.

The present invention is not particularly limited to the embodiments described above, and various modifications thereto are possible without departing from the essence and gist of the present invention.

1. A rotating electric machine comprising a stator and a rotor disposed inside the stator,
wherein the stator includes a stator core and an electromagnetic coil provided in a plurality of slots, and the stator core includes: a yoke portion having an annular shape; a plurality of teeth portions provided at intervals in a circumferential direction of the stator, and each including a base portion protruding from an inner circumferential surface of the yoke portion and extending in a diametrical direction of the yoke portion as an extending direction; and the plurality of slots each being formed between adjacent ones of the plurality of teeth portions in the circumferential direction,
the rotor includes a plurality of permanent magnets facing the plurality of teeth portions inside the stator,
the plurality of permanent magnets include two or more combinations of a first magnet, a second magnet adjacent to the first magnet, a third magnet adjacent to the first magnet, and a fourth magnet adjacent to the third magnet, a direction of a magnetic field of the first magnet facing diametrically inward of the yoke portion, a direction of a magnetic field of the second magnet being a clockwise or counterclockwise direction, a direction of a magnetic field of the third magnet being the counterclockwise or clockwise direction opposite to the direction of the second magnet, and a direction of a magnetic field of the fourth magnet facing diametrically outward of the yoke portion,
a position of an inner circumferential side end surface of the electromagnetic coil is shifted from an inner circumferential side end of the base portion toward the yoke portion, and
when a direction that is perpendicular to the extending direction is defined as a widthwise direction, in each of the plurality of the slots, a dimension of each of the slots in the widthwise direction at a position of the inner circumferential side end surface of the electromagnetic coil is defined as a first distance, and a separation distance between inner circumferential side end surfaces of the teeth portions adjacent to each other in the widthwise direction is defined as a second distance, the second distance is 0.5 times or more the first distance.

2. The rotating electric machine according to claim 1, wherein the second distance is smaller than the first distance.

3. The rotating electric machine according to claim 1, wherein each of the teeth portions includes a flange portion which is located further on an inner circumferential side of the stator core than the inner circumferential side end of the base portion, and which has a dimension in the widthwise direction larger than a dimension in the widthwise direction of the base portion, and
the electromagnetic coil is shifted from an inner circumferential side end surface of the flange portion by a shift amount of 5% to 11% of a total length of each of the teeth portions.

4. The rotating electric machine according to claim 3, wherein when the total length of each of the teeth portions is 100%, a length of the base portion is 96% or more.

5. The rotating electric machine according to claim 4, wherein a distance from the inner circumferential side end surface to an outer circumferential side end portion of the flange portion is 0.2 mm to 2.0 mm.

6. The rotating electric machine according to claim 1, wherein when a number of poles is defined as twice a number of combinations of the first magnet to the fourth magnet, the number of poles is an even number of 8 or more and 12 or less, and a number of the teeth portions is a multiple of three and is 24 or more and 48 or less.

7. The rotating electric machine according to claim 6, wherein an outer diameter of the stator core is 100 mm to 200 mm.

8. The rotating electric machine according to claim 7, wherein a total length of each of the teeth portions is 40 mm to 45 mm.
